(19) United States
(12) Patent Application Publication
(10) Pub. No.: US 2012/0148848 A1
(43) Pub. Date: Jun. 14, 2012

(54) POLYMERIC SUBSTRATES HAVING A THIN METAL FILM AND FINGERPRINT RESISTANT CLEAR COATING DEPOSITED THEREON AND RELATED METHODS

(76) Inventors: David C. Martin, Bethel Park, PA (US); Kurt A. Humbert, Pittsburgh, PA (US); Brian K. Rearick, Allison Park, PA (US)

(21) Appl. No.: 13/050,118

(22) Filed: Mar. 17, 2011

Related U.S. Application Data
(60) Provisional application No. 61/421,667, filed on Dec. 10, 2010.

(51) Int. Cl. B05D 7/00; B32B 27/28; B05D 1/36; B32B 15/00

(52) U.S. Cl. 428/421; 428/457; 427/404

(57) ABSTRACT

Disclosed are methods of coating a polymeric substrate. The methods include (a) depositing a thin metal film onto the polymeric substrate, and (b) depositing a transparent radiation curable film-forming composition onto a thin metal film, wherein the transparent radiation curable film-forming composition comprises a fluorine-containing radiation curable compound.

### CROSS-REFERENCE TO RELATED APPLICATIONS

This application claims the benefit of U.S. Provisional Patent Application Ser. No. 61/421,667, filed Dec. 10, 2010, which is incorporated by reference herein in its entirety.

### FIELD OF THE INVENTION

The present invention is directed to polymeric substrates having a thin metal film deposited thereon and a clear coating exhibiting desirable appearance and fingerprint resistance properties deposited on the thin metal film, as well as related methods for coating a substrate.

### BACKGROUND OF THE INVENTION

Polymeric substrates are desired for a number of applications, such as for consumer electronics devices (including, for example, cellular telephones, personal digital assistants, smart phones, personal computers, digital cameras, and the like), among other things. Usually for aesthetic reasons, it is sometimes desired to impart a metallic appearance to such polymeric substrates. To do this, thin metal films are sometimes deposited onto the substrate followed by a protective coating system that may include one or more coating layers.

In some applications, such as when a coating is to be applied to an article that is often handled by a person, such as a consumer electronics device, it may be desirable to have a coating that is resistant to fingerprint stains. As such, it is often desirable that such coatings exhibit oleophobicity (incompatibility with nonaqueous organic substances).

In addition, many substrate materials used in the production of the foregoing articles, such as plastics, can be sensitive to the application of heat. Therefore, coating compositions that require heat to cure may not be suitable. For this reason, as well as environmental advantages and reduced energy usage, it may be desirable to employ radiation curable coatings, such as those cured by exposure to ultraviolet (“UV”) radiation, in such applications, especially when the coating composition is transparent to such radiation, such as is the case with transparent topcoats.

As a result, it would be desirable to provide polymeric substrates having a thin metal film deposited thereon and a clear coating exhibiting desirable appearance and fingerprint resistance properties deposited on the thin metal film, while employing a radiation curable transparent clear coating.

### SUMMARY OF THE INVENTION

In certain respects, the present invention is directed to methods of coating a polymeric substrate. The methods comprise depositing a transparent radiation curable film-forming composition over a thin metal film deposited over the polymeric substrate, wherein the transparent radiation curable film-forming composition comprises a fluorine-containing radiation curable compound.

In other respects, the present invention is directed to polymeric substrates comprising a thin metal film depositing onto at least a portion of the substrate and a transparent topcoat over the thin metal film, wherein the transparent topcoat comprises a radiation cured composition comprising a fluorine-containing radiation cured compound.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As indicated, certain embodiments of the present invention are directed to methods of coating a polymeric substrate. Examples of polymeric substrates suitable for use in the present invention included, but are not limited to, substrates constructed of polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers—such as gelatin.

In certain embodiments, the substrate comprises a polyamide, such as a reinforced polyamide substrate.

As used herein, the term “polyamide substrate” refers to a substrate constructed from a polymer that includes repeating units of the formula:

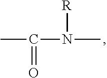

wherein R is hydrogen or an alkyl group. The polyamide may be any of a large class of polyamides based on aliphatic, cycloaliphatic, or aromatic groups in the chain. They may be formally represented by the products of condensation of a dibasic amine with a diacid and/or diacid chloride, by the product of self-condensation of an amino acid, such as omega-aminoundecanoic acid, or by the product of a ring-opening reaction of a cyclic lactam, such as caprolactam, lauryllactam, or pyrrolidone. They may contain one or more alkylene, arylene, or aralkylene repeating units. The polyamide may be crystalline or amorphous. In certain embodiments, the polyamide substrate comprises a crystalline polyamide of alkylene repeating units having from 4 to 12 carbon atoms, such as poly(caprolactam), known as nylon 6, poly(lauryllactam), known as nylon 12, poly(omega-aminoundecanoic acid), known as nylon 11, poly(hexamethylene adipamide), known as nylon 6.6, poly(hexamethylene sebacamide), known as nylon 6.10, and/or an alkylene/arylene copolyamide, such as that made from meta-xylylene diamine and adipic acid (nylon MXD6). Amorphous polyamides, such as those derived from isophoronediamine or trimethylcyclohexanediamine, may also be utilized.

As used herein, the term “reinforced polyamide substrate” refers to a polyamide substrate constructed from a polyamide that has been reinforced through the inclusion of, for example, fibrous materials, such as glass fiber or carbon fiber, or inorganic fillers, such as calcium carbonate, to produce a polyamide having increased rigidity, strength, and/or heat resistance relative to a similar polyamide that does not include such reinforcing materials. Reinforced polyamides, which are suitable for use as a substrate material in accordance with certain embodiments of the present invention, are commercially available and include, for example, those materials commercially available from Solvay Advanced Polymers under the IXEF® name and, include, for example, the IXEF 1000, 1500, 1600, 2000, 2500, 3000 and 5000 series products; from EMS-Chemie Inc., Sumter, S.C., U.S.A. under the Grilamid®, Grivory®, Grilon® and Grilflex® tradenames; and DuPont Engineered Polymers, such as those sold under the Thermx® and Minion® tradenames.

In certain embodiments of the present invention, the polymeric substrate itself is opaque, i.e., not transparent.

In the methods of the present invention, the polymeric substrate has a thin metal film deposited thereon. As used herein, “thin metal film” refers to metal films having a thickness of at least 0.2 millimicrons (0.2 nanometers, 2 angstroms), such as at least 10 millimicrons (10 nanometers, 100 angstroms) and no more than 5,000 millimicrons (5,000 nanometers, 50,000 angstroms), such as no more than 1,000 millimicrons (1,000 nanometers, 10,000 angstroms).

The thin metal film may comprise any of a variety of metals, such as, for example, aluminum, nickel, copper, chromium, indium, stainless steel, stannum, including alloys of any of the foregoing, which can be applied to a polymeric substrate. Such thin metal films may be deposited upon the polymeric substrate by any technique of vacuum metallizing, such as evaporation, sputtering, electroless deposition, and electroplating. The thin metal film may be deposited directly upon the polymeric substrate or, in some cases, one or more intervening coating layers may be deposited between the substrate and the thin metal film.

As will be appreciated, in certain embodiments, the thin metal film is free of any resinous materials, and often consists only of one or more of the previously identified metals.

As previously indicated, the methods of the present invention comprise applying over the thin metal film a transparent radiation curable film-forming composition to form a transparent top coat over the thin metal film. As used herein, “transparent” means a coating that is not opaque, that is, the coating does not hide an underlying surface when viewed with the naked eye. Such transparent coatings can be colorless or colored. The transparent radiation curable film-forming composition described herein may be deposited directly upon the thin metal film or, in some cases, one or more intervening coating layers may be deposited between the transparent radiation curable film-forming composition described herein and the thin metal film.

Also, it should be understood that as used herein, when it is stated that a transparent radiation curable film-forming composition is deposited “over” a thin metal film it is meant that the transparent radiation curable film-forming composition can be deposited directly over the thin metal film or one or more coating layers may be present between the thin metal film and the transparent radiation curable film-forming composition. For example, and without limitation, in some embodiments, a tinted (semi-transparent) colored layer may be deposited between the thin metal film and the transparent radiation curable film-forming composition.

Such tinted colored layers can comprise any of a variety of thermoplastic and/or thermosetting compositions known in the art. As will be appreciated, thermosetting coating compositions typically comprise a crosslinking agent that may be selected from, for example, aminoplasts, polyisocyanates including blocked isocyanates, polyepoxides, beta-hydroxyalkylamides, polyacids, anhydrides, organometallic acid-functional materials, polyamines, polyamides, and mixtures of any of the foregoing. In addition to or in lieu of the above-described crosslinking agents, such compositions typically comprise at least one film-forming resin. Thermosetting or curable coating compositions typically comprise film forming polymers having functional groups that are reactive with the crosslinking agent. The film-forming resin may be selected from any of a variety of polymers, such as, for example, acrylic polymers, polyester polymers, polyurethane polymers, polyamide polymers, polyether polymers, polysiloxane polymers, copolymers thereof, and mixtures thereof. Functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof.

As used herein, a “radiation curable film-forming composition” refers to a composition that includes a radiation curable compound. As used herein, a “radiation-curable compound” refers to any compound that, when exposed to radiation, will undergo crosslinking with itself and/or another radiation-curable compound. Often, such compounds comprise a “radiation-curable moiety” through which radiation cure occurs. Such moieties may, for example, comprise C═CH₂ functionality. These compounds may further comprise a second functionality such as hydroxy, thiol, primary amines and/or secondary amines, among others.

In certain embodiments, the radiation-curable compound comprises a (meth)acrylic polymer or copolymer. As used herein, “(meth)acrylic” and like terms refers both to the acrylic and the corresponding methacrylic. Suitable (meth)acrylic polymers include (meth)acrylic functional (meth)acrylic copolymers, epoxy resin (meth)acrylates, polyester (meth)acrylates, polyether (meth)acrylates, polyurethane (meth)acrylates, amino(meth)acrylates, silicone (meth)acrylates, and melamine(meth)acrylates. The number average molecular weight (“Mn”) of these compounds can range from 200 to 10,000, such as 1200 to 3000. These compounds can contain any number of olefinic double bonds that allow the compound to be polymerized upon exposure to radiation; in certain embodiments, the compounds have an olefinic equivalent weight of 500 to 2000. The (meth)acrylic polymers can be (cyclo)aliphatic and/or aromatic.

In certain embodiments, the (meth)acrylic copolymer comprises a urethane linkage, and in certain other embodiments can comprise a urethane linkage, a terminal acrylate group, and a hydroxy group. Specific examples of polyurethane (meth)acrylates are reaction products of a polyisocyanate such as 1,6-hexamethylene diisocyanate and/or isophorone diisocyanate, including isocyanurate and biuret derivatives thereof, with hydroxyalkyl(meth) acrylate such as hydroxyethyl(meth)acrylate and/or hydroxypropyl(meth)acrylate. The polyisocyanate can be reacted with the hydroxyalkyl(meth)acrylate in a 1:1 equivalent ratio or can be reacted with an NCO/OH equivalent ratio greater than 1 to form an NCO-containing reaction product that can then be chain extended with a polyol such as a diol or triol, for example 1,4-butane diol, 1,6-hexane diol and/or trimethylol propane. Examples of polyester (meth)acrylates are the reaction products of a (meth)acrylic acid or anhydride with a polyol, such as diols, triols and tetraols, including alkylated polyols, such as propoxylated diols and triols. Examples of polyols include 1,4-butane diol, 1,6-hexane diol, neopentyl glycol, trimethylol propane, isosorbide, pentaerythritol and propoxylated 1,6-hexane diol.

In certain embodiments, such polymer(s) are present in the radiation curable composition in an amount ranging from 10 to 90 percent by weight, such as from 10 to 50, or, in some cases, 20 to 40 percent weight, based on the total weight of the first radiation curable composition.

The radiation curable coating composition may further comprise at least one multi-functional (meth)acrylate monomers, which refers to monomers having a (meth)acrylate functionality of greater than 1.0, such as at least 2.0. Multifunctional acrylates suitable for use in the compositions of the present disclosure include, for example, those that have a relative molar mass of from 170 to 5000 grams per mole, such as 170 to 1500 grams per mole. In the compositions of the present disclosure, the multifunctional acrylate may act as a reactive diluent that is radiation curable. Upon exposure to radiation, a radical induced polymerization of the multi-functional (meth)acrylate with monomer is induced, thereby incorporating the reactive diluent into the coating matrix.

Multi-functional (meth)acrylates suitable for use in the radiation curable compositions of the present disclosure may include, without limitation, difunctional, trifunctional, tetrafunctional, pentafunctional, hexafunctional (meth)acrylates and mixtures thereof.

Representative examples of suitable multi-functional (meth)acrylates include, without limitation, ethylene glycol di(meth)acrylate, 1,3-butylene glycol di(meth)acrylate, 1,4-butanediol diacrylate, 2,3-dimethylpropane1,3-diacrylate, 1,6-hexanediol di(meth)acrylate, dipropylene glycol diacrylate, ethoxylated hexanediol di(meth)acrylate, propoxylated hexanediol di(meth)acrylate, neopentyl glycol di(meth)acrylate, alkoxylated neopentyl glycol di(meth)acrylate, hexylene glycol di(meth)acrylate, diethylene glycol di(meth)acrylate, tripropylene glycol di(meth)acrylate, thiodiethyleneglycol diacrylate, trimethylene glycol dimethacrylate, pentaerythritol tri(meth)acrylate, trimethylolpropane tri(meth)acrylate, ditrimethylolpropane tetra(meth)acrylate, glycerolpropoxy tri(meth)acrylate, ethoxylated trimethylolpropane tri(meth)acrylate, and tetraethylene glycol di(meth)acrylate, including mixtures thereof.

In certain embodiments, the multifunctional (meth)acrylate monomer is present in the radiation curable composition in an amount ranging from 1 to 30 percent by weight, such as from 1 to 20, or, in some cases, 5 to 15 percent weight, based on the total weight of the radiation curable film-forming composition.

As previously indicated, in the present invention, the transparent radiation curable film-forming composition comprises a fluorine-containing radiation curable compound. A suitable class of such compounds can be represented by the general formula (I):

(R_{A})ₓ—W—(R_{f})_{y} (I)

wherein: (i) each R_{A} independently represents a radiation curable moiety, such as a moiety comprising a (meth)acrylate group, each R_{f} independently represents a fluorinated moiety, x is at least 2, such as from 2 to 5; y is at least 1, such as 1 to 5; and W is a group linking R_{A} and R_{f}. Some examples of fluorine-containing radiation curable compounds that are suitable for use in the present invention are described in U.S. Pat. No. 6,238,798 at col. 4, line 21 to col. 7, line 34, the cited portion of which being incorporated herein by reference.

In some embodiments, the fluorine-containing radiation curable compound comprises a perfluoro-type polymer. As used herein, a perfluoro-type polymer refers to a polymer in which most of or all of hydrogen of alkyl groups and/or alkylene groups in the polymer are substituted with a fluorine. As used herein, a polymer in which 85% or more of hydrogen of alkyl groups and/or alkylene groups are substituted with a fluorine, is defined as a perfluoro-type polymer.

In certain embodiments, the fluorine-containing radiation curable compound comprises a perfluoropolyether (PFPE) and one or more, often two or more, polymerizable unsaturated groups, such as (meth)acrylate groups, per molecule. Fluorine-containing radiation curable compounds can be derived from, for example, a polyisocyanate, such as a triisocyanate, reacted with a hydroxyl-functional fluoropolymer and a hydroxyl-functional (meth)acrylate. Thus, in certain embodiments, the fluorine-containing radiation curable compound of structure (I) is represented by the general structure (Ia).

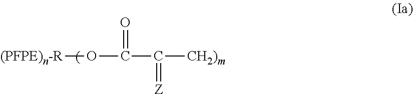

in which: (a) each n and m is independently 1 or 2 (in some embodiments m+n=3); (b) R is a linking group (in some embodiments R comprises one or more urethane linkages); and (c) Z is H or CH₃.

One example of a commercially available fluorine-containing radiation curable compound of this type is Optool DAC, manufactured by Daikin Industries, Ltd., which is believed to have the structure (Ib).

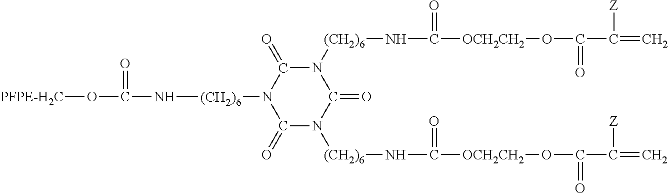

in which Z is H or CH₃ and PFPE has the structure:

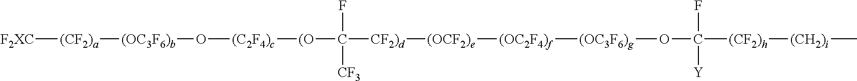

wherein: X and Y are each independently F or CF₃; a is an integer in the range of 1 to 16; b, d, e, f and g are each independently an integer in the range of 0 to 200; c is an integer in the range of 0 to 5; and h and I are each independently an integer in the range of 0 to 16. Another example is a compound having the following structure:

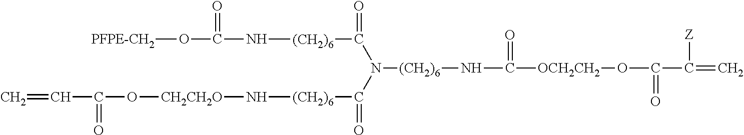

In certain embodiments, the weight average molecular weight of the fluorine-containing radiation curable compound is from 400 to 40,000, such as 400 to 5000, or, in some cases, 800 to 4000 or 1000 to 3000.

Further, in some embodiments of the present invention the fluorine-containing radiation curable compound comprises a compound represented by the following formula (II).

(Rf¹)—[(W)−(R_{A})ₙ]ₘ (II)

wherein: Rf¹ represents a (per)fluoroalkyl group or a (per)fluoropolyether group; W represents a single bond or a linking group; R_{(A)} represents a functional group having an unsaturated double bond; n represents an integer of 1 to 3, such as 2 to 3; and m represents an integer of 1 to 3, such as 2 to 3.

In formula (II), W represents, for example, alkylene, arylene, heteroalkylene, or a combined linking group thereof. These may further contain each of the structures such as carbonyl, carbonyloxy, carbonylimino, urethane, ester, amide, sulfoneamide, and the like, and a linking group having a combined structure thereof.

In formula (II), R_{(A)} may comprise, for example:

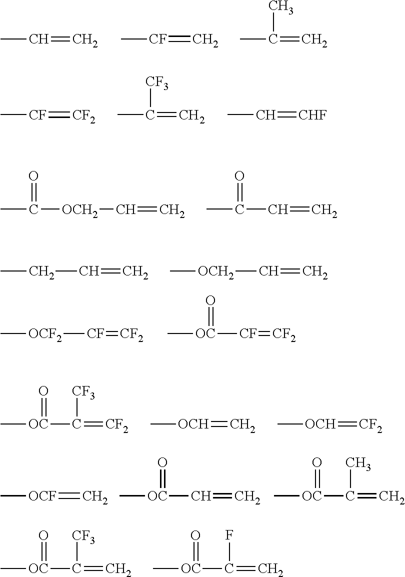

In some embodiments, n and m in formula (II) are both 1, specific examples of which include compounds represented by the formulae (III), (IV) and (V).

Rf¹¹(CF₂CF₂)ₙCH₂CH₂—(W)—OCOCR¹═CH₂ (III)

F(CF₂)ₚ—CH₂CHX—CH₂Y (IV)

F(CF₂)ₙO(CF₂CF₂O)ₘCF₂CH₂OCOCR═CH₂ (V)

In formula (III), Rf¹¹ represents at least one of fluorine atom and a fluoroalkyl group having 1 to 10 carbon atoms; R¹ represents a hydrogen atom or a methyl group; W represents a single bond or a linking group; n represents an integer of no less than 2.

In formula (IV), p is an integer of Ito 20, such as 6 to 20 or 8 to 10, and X and Y are either a (meth)acryloyloxy group or a hydroxyl group, and at least one thereof is a (meth)acryloyloxy group.

In the formula (V), R is a hydrogen atom or a methyl group, m is an integer of 1 to 20, and n represents an integer of 1 to 4. Such compounds can be obtained by reacting a (meth)acrylic acid halide with a fluorine atom-containing alcohol compound represented by the following formula (VI):

F(CF₍₂₎)₍ₙ₎O(CF₍₂₎CF₍₂₎O₍ₘ₎CF₍₂₎CH₍₂₎OH (VI)

wherein m represents an integer of 1 to 20 and n represents an integer of 1 to 4.

In certain embodiments, the fluorine-containing radiation curable compound comprises a compound represented by the following formula (VII).

RF¹²—[(O)_{c}(O═C)_{b}(CX⁴X⁵)ₐ—CX³═CX¹X²]_{d} (VII)

wherein X¹ and X² each independently represents H or F; X³ represents H, F, CH₃, or CF₃; X⁴ and X⁵ each independently represents H, F, or CF₃; a, b, and c each independently represents 0 or 1; d represents an integer of 1 to 4; Rf¹² represents a group having an ether bond having 18 to 200 carbon atoms and has 6 or more, such as 6.5 to 8, 10 or more, 18 to 22, or, in some cases, 20 or more repeating units repeating units represented by the formula —(CX⁶X⁷CF₂CF₂O)— (wherein X⁶ and X⁷ each independently represents F or H). Such compounds are described in WO2003/022906.

In some embodiments, n and m in formula (II) are not both 1.

Rf¹ which is monovalent to trivalent can be used. In the case where the Rf¹ is monovalent, exemplary terminal groups include (CₙF₂ₙ₊₁)—, (CₙF₂ₙ₊₁O)—, (XCₙF₂ₙO)—, or (XCₙF₂ₙ₊₁)— (wherein X is hydrogen, chlorine, or bromine, and n is an integer of 1 to 10), such as is the case with CF₃O(C₂F₄O)ₚCF₂—, C₃F₇O(CF₂CF₂CF₂O)ₚCF₂CF₂—, C₃F₇O(CF(CF₃)CF₂O)ₚCF(CF₃)—, and F(CF(CF₃)CF₂O)ₚCF(CF₃)—, wherein the average value of p is from 0 to 50, such as 3 to 30, 3 to 20, or 4 to 15.

In the case where Rf¹ is divalent, exemplary groups include —(CF₂O)_{q}(C₂F₄O)ᵣCF₂—, —(CF₂)₃O(C₄F₈O)ᵣ(CF₂)₃—, —CF₂O(C₂F₄O)ₙCF₂—, —C₂F₄O(C₃F₆O)ᵣC₂F₄—, —CF(CF₃)(OCF₂CF(CF₃))ₛOCₜF₂ₜO(CF(CF₃)CF₂O)ᵣCF(CF₃)—, wherein q, r, and s in the formula are average values from 0 to 50, such as 3 to 30, 3 to 20, or 4 to 15, and t is an integer of 2 to 6. Specific examples or synthesis methods for such compounds are described in WO 2005/113690.

In certain embodiments, the fluorine-containing radiation curable compound is present in the radiation curable composition in an amount ranging from 0.1 to 10 percent by weight, such as from 0.2 to 10, or, in some cases, 0.5 to 6 percent weight, based on the total weight of the radiation curable film-forming composition.

In some embodiments, the radiation curable film-forming composition further comprises inorganic fine particles, such as inorganic oxide particles. In some embodiments, these particles are substantially spherical in shape, relatively uniform in size (have a substantially monodisperse size distribution) or a polymodal distribution obtained by blending two or more substantially monodisperse distributions.

It certain embodiments, the fine particles have an average particle diameter of 1 to 200 nanometers, such as 1 to 100 nanometers, or, in some cases, 2 to 75 nanometers. Average particle size of the colloidal inorganic oxide particles can be measured using transmission electron microscopy, as will be appreciated by those skilled in the art, to count the number of colloidal inorganic oxide particles of a given diameter.

A wide range of inorganic oxide particles can be used, such as silica, titania, alumina, zirconia, vanadia, chromia, iron oxide, antimony oxide, tin oxide, and mixtures thereof. The colloidal inorganic oxide particles can comprise essentially a single oxide such as silica, a combination of oxides, such as silica and aluminum oxide, or a core of an oxide of one type (or a core of a material other than a metal oxide) on which is deposited an oxide of another type.

In certain embodiments, the inorganic particles are provided in the form of a sol (e.g., colloidal dispersions of inorganic particles in liquid media), such as where the liquid media comprises water or, in some cases, the particles are dispersed in a radiation curable compound, such as any of those described earlier. In certain embodiments, the sol contains from 2 to 50 weight percent, such as 25 to 45 weight percent, of colloidal inorganic oxide particles based on the total weight of the sol. Such sols can be prepared by methods well known in the art.

In certain embodiments, the inorganic fine particles are surface treated, such as with a fluorosilane surface treatment, wherein “fluorosilane” refers to a surface treatment agent comprising at least one hydrolyzable or hydrolyzed silane moiety and at least one fluorinated moiety. Additionally, suitable fluorosilane components can be polymers, oligomers, or monomers and often comprise one or more fluorochemical moieties that contain a fluorinated carbon chain having from 3 to 20, such as 6 to 14, carbon atoms. The fluorochemical moiety may be linear, branched, or cyclic or any combination thereof. The fluorochemical moiety is usually free of curable olefinic unsaturation but can optionally contain in-chain heteroatoms such as oxygen, divalent or hexavalent sulfur, or nitrogen. Perfluorinated groups are often used, but hydrogen or halogen atoms can also be present as substituents.

A class of useful fluorosilane surface treatment agents can be represented by the following general formula (VIII):

(S_{y})ₜ—W—(R_{f})ₛ (VIII)

wherein each S_{y} independently represents a hydrolyzable silane moiety, R_{f} is F or a fluorinate moiety, r is at least 1, such as 1-4; s is at least 1, such as 1-4; and W is a single bond or a linking group.

In certain embodiments, each S_{y} moiety of Formula (VIII) independently is a monovalent or divalent, nonionic hydrolyzable silane moiety that may be linear, branched, or cyclic. As used herein, the term “hydrolyzable silane moiety” with respect to S_{y} refers to a hydrolyzable silane moiety comprising at least one Si atom bonded to at least one halogen atom and/or at least one oxygen atom in which the oxygen atom preferably is a constituent of an acyloxy group and/or an alkoxy group.

Representative specific examples of suitable compounds according to Formula (VIII) include: FSi(OCH₂CH₃)₃, C₅F₁₁CH₂OCH₂CH₂CH₂Si(OCH₂CH₃)₃, C₇F₁₅CH₂OCH₂CH₂CH₂Si(OCH₂CH₃)₃, C₇F₁₅CH₂OCH₂CH₂CH₂SiCl₃, C₈F₁₇CH₂CH₂OCH₂CH₂CH₂SiCl₃, C₁₈F₃₇CH₂OCH₂CH₂CH₂CH₂SiCl₃, CF₃CF(CF₂Cl)CF₂CF₂SO₂N(CH₃)CH₂CH₂CH₂SiCl₃, C₈F₁₇SO₂N(CH₂CH₃)CH₂CH₂CH₂Si(OCH₃)₃, C₈F₁₇SO₂N(CH₃)CH₂CH₂CH₂Si(OCH₃), C₈F₁₇SO₂N(CH₂CH₃)CH₂CH₂CH₂Si(OCH₃)_{av1.9}[(OCH₂CH₂)_{av6.1}OCH₃]_{av1.1}, C₇F₁₅CH₂OCH₂)₃Si(OCH₂CH₂OCH₂CH₂OH)₃, C₇F₁₅CH₂CH₂Si(CH₃)Cl₂, C₇H₁₅CH₂CH₂SiCl₃, C₈F₁₇CH₂CH₂SiCl₃, Cl₃SiCH₂CH₂CH₂OCH₂CF₂(OCF₂CF₂)₈OCF₂CH₂OCH₂CH₂CH₂SiCl₃, CF₃O(CF₂CF(CF₃)₃O)₄CF₂C(═O)NHCH₂CH₂CH₂Si(OC₂H₅)₃, CF₃O(C₃F₆O)₄(CF₂O)₃CF₂CH₂OC(═O)NHCH₂CH₂CH₂Si(OCH₃)₃, Cl₃SiCH₂CH₂OCH₂(CF₂CF₂O)₈(CF₂O)₄CF₂CH₂CH₂CH₂SiCl₃, C₈F₁₇CONHC₆H₄Si(OCH₃)₃, and C₈F₁₇SO₂N(CH₂CH₃)CH₂CH₂CH₂Si(OCH₃)ₐᵥ₁(OCH₂CH₂(OCH₂CH₂)₂OCH₃)ₐᵥ₂.

As will be appreciated, useful fluorosilane components can be prepared, e.g., by reacting: (a) at least one fluorochemical compound having at least one reactive functional group with (b) a functionalized silane having from one to about three hydrolyzable groups and at least one alkyl, aryl, or alkoxyalkyl group that is substituted by at least one functional group that is capable of reacting with the functional group of the fluorochemical compound(s). Such methods are disclosed in U.S. Pat. No. 5,274,159 (Pellerite et al.).

In addition to the previously described components, the transparent radiation curable film-forming composition may further include other optional additives, such as solvents, surfactants, antistatic agents, leveling agents, initiators, photosensitizers, stabilizers, absorbers, antioxidants, crosslinking agents, fillers, fibers, lubricants, pigments, dyes, plasticizers, suspending agents and the like.

Depending upon the energy source used to cure the transparent radiation-curable composition used in the methods of the present invention, an initiator may be required to generate the free radicals which initiate polymerization. Examples of suitable free radical initiators that generate a free radical source when exposed to thermal energy include, but are not limited to, peroxides such as benzoyl peroxide, azo compounds, benzophenones, and quinones. Examples of photoinitiators that generate a free radical source when exposed to visible light radiation include, but are not limited to, camphorquinones/alkylamino benzoate mixtures. Examples of photoinitiators that generate a free radical source when exposed to ultraviolet light include, but are not limited to, organic peroxides, azo compounds, quinones, benzophenones, nitroso compounds, acryl halides, hydrozones, mercapto compounds, pyrylium compounds, triacrylimidazoles, bisimidazoles, chloroalkylriazines, benzoin, benzoin methyl ether, benzoin ethyl ether, benzoin isopropyl ether, benzoin isobutyl ethers and methylbenzoin, diketones such as benzil and diacetyl, phenones such as acetophenone, 2,2,2-tri-bromo-1-phenylethanone, 2,2-diethoxyacetophenone, 2,2-dimethoxy-2-phenylacetophenone, 2,2,2,-tribromo-1(2-nitrophenyl)ethanone, benzophenone, 4,4-bis(dimethyamino)benzophenone, and acyl phosphates. Examples of commercially available ultraviolet photoinitiators include those available under the trade designations IRGACURE 184 (1-hydroxycyclohexyl phenyl ketone), IRGACURE 361 and DAROCUR 1173 (2-hydroxy-2-methyl-1-phenyl-propan-1-one) from Ciba-Geigy. In certain embodiments, the initiator is used in an amount of from 0.1 to 10 percent by weight, such as 1 to 5 percent by weight, based on the total weight of the transparent radiation-curable composition.

In certain embodiments, the transparent radiation-curable composition includes a photosensitizer, which aids in the formation of free radicals, especially in an air atmosphere. Suitable photosensitizers include, but are not limited to, aromatic ketones and tertiary amines. Suitable aromatic ketones include, but are not limited to, benzophenone, acetophenone, benzil, benzaldehyde, and o-chlorobenzaldehyde, xanthone, thioxanthone, 9,10-anthraquinone, and many other aromatic ketones. Suitable tertiary amines include, but are not limited to, methyldiethanolamine, ethyldiethanolamine, triethanolamine, phenylmethyl-ethanolamine, dimethylaminoethylbenzoate, and the like. In certain embodiments, the photosensitizer is used in an amount of from 0.01-10 percent by weight, such as 0.05 to 5 percent by weight, based on the total weight of the composition.

In the methods of the present invention, the transparent radiation curable film-forming composition is applied over the thin metal film to form a transparent top coat over the thin metal film. The transparent radiation-curable film-forming composition may be applied by one or more of a number of methods including spraying, rolling, curtain coating, dipping/immersion, brushing, or flow coating. Usual spray techniques and equipment for air spraying and electrostatic spraying and either manual or automatic methods can be used. The dry film thickness of the topcoat may be, for example, 1 to 50 microns, such as 12 to 25 microns.

As will be appreciated, the present invention is also directed to polymeric substrates comprising a thin metal film depositing over at least a portion of the substrate and a transparent topcoat over the thin metal film, wherein the transparent topcoat comprises a radiation cured composition comprising a fluorine-containing radiation cured compound.

The polymeric substrates of the present invention can, in at least some cases, find particular application in the consumer electronics market. As a result, the present invention is also directed to a consumer electronics device, such as a cell phone, personal digital assistant, smart phone, personal computer, digital camera, or the like, which is at least partially coated with a thin metal film clear coating system of the present invention.

### EXAMPLES

Compositions as set forth in Table 1 (amount in parts by weight) were prepared in a 250 ml metal can and all components were added in order from top to bottom while under agitation. The final mixtures were allowed to rest and equilibrate for a minimum of 16 hours before application and testing.

TABLE 1

| Raw material | Example A | Example B |
|---|---|---|
| Normal Butyl Acetate¹ | 10.00 | 9.77 |
| Methyl Isobutyl Ketone¹ | 2.00 | 1.95 |
| Isopropanol¹ | 4.13 | 4.03 |
| Xylene² | 12.50 | 12.21 |
| SR-351H³ | 10.00 | 9.77 |
| Etercure 6175-1⁴ | 21.29 | 20.79 |
| BYK ®-306⁵ | 0.30 | — |
| BYK ®-333⁵ | 0.30 | — |
| Megaface RS-75⁶ | — | 2.93 |
| Etercure 6145-100⁴ | 27.32 | 26.68 |
| Etercure 6130B-80⁴ | 9.16 | 8.95 |
| Darocur ® 1173⁷ | 3.00 | 2.93 |

¹Commercially available from Dow Chemical Company
²Commercially available from Shell Chemicals
³Commercially available from Sartomer USA, LLC
⁴Commercially available from Eternal Chemical Col. Ltd.
⁵Commercially available from BYK-Chemie GmbH
⁶Commercially available from Dainippon Ink Co.
⁷Commercially available from CIBA Specialty Chemicals

A series of coatings were applied over a non-metallic PC/ABS test plaque. The coating type, application method, flash, cure conditions and dry film thickness (DFT) are listed in Table 2. The coating layer number represents the order in which it was applied with number 1 being the first coat applied to the substrate and all subsequent coatings are applied to the previous layer after curing.

TABLE 2

| | | | Ambient | | Target UV | |
|---|---|---|---|---|---|---|
| | | | flash before | | cure | |
| Coating | Coating code | Application | thermal | Thermal | conditions - | |
| layer | and/or type | method | bake | bake | H type lamp | DFT |
| 1 | R66052¹ | Air atomized | 5 minutes | 8 minutes @ | 1000 mJ/cm² | 18-22 microns |
| | basecoat | spray gun | | 60° C. | (UV-A - | |
| | | | | | 320-390 nm) | |
| 2 | Indium and | Evaporation | — | — | — | — |
| | Tin metallic | | | | | |
| | alloy coat² | | | | | |
| 3 | XPB67381VS³ | Air atomized | 5 minutes | 10 minutes @ | — | 6-8 microns |
| | middle coat | spray gun | | 60° C. | | |
| 4 | Examples A | Air atomized | 5 minutes | 8 minutes @ | 1400 mJ/cm² | 17-20 microns |
| | and B | spray gun | | 60° C. | (UV-A - | |
| | | | | | 320-390 nm) | |

¹UV curable primer commercially available from PPG Industries, Inc.
²Commercially available from Vacmart, Shanghai, China
³Commercially available from PPG Industries, Inc.

Surface energy measurements were performed on the test plaques using a Kruss DSA 100 drop shape analyzer along with the DSA1 version-1.90.0.14 software. First, a 2 μl drop of HPLC grade water was applied to a virgin area on the test plaque and a minimum of 2 test drops are measured and averaged. Next, a 1-2 μl drop of Squalene (CAS#111-02-4) was applied to a virgin area on the test plaque and a minimum of 2 test drops were measured and averaged. All individual measurements are made on a virgin area of the test plaque.

The drop contact angles were evaluated via the tangent method 2 routine in the software that fits the profile of the sessile drop. The total surface energy, dispersive component and polar component are calculated in mN/m from the contact angles of water and squalene using the Owens, Wendt, Rabel and Kaeble method. (References: Kruss DSA1 v1.9-03 software user manual, Kruss DSA100 v1-06 operation manual).

Visual observations were made by applying a number of fingerprints (generally between 5 and 10) to the coated surface of each test plaque either by one or more than one person. Samples were compared to one another and ranked accordingly. Fingerprint removal testing was done by using a soft paper towel such as WYPALL L30 from Kimberly Clark (new piece for each test) and each plaque is rubbed in the same manner and number of times to see how easy or hard it was to remove the fingerprint, or make them less noticeable. The fingerprints or smears after cleaning appeared white. The Squalene drops from the surface energy measurements are wiped in the same manner and evaluated using the same method to see how easy the Squalene was removed from the test coating. Results are set forth in Table 3.

TABLE 3

| | Total | | | Water | | | Fingerprint |
|---|---|---|---|---|---|---|---|
| | Surface | Dispersive | Polar | Contact | Squalene | Squalene | (FP) |
| Clearcoat | energy | Component | Component | Angle | Contact | removal | removal |
| Example | (mN/m) | (mN/m) | (mN/m) | (°) | Angle (°) | comments | comments |
| Example A | 25.4 | 23.4 | 2.0 | 96.1 | 40.9 | Squalene | FP was |
| | | | | | | was | smeared and |
| | | | | | | discolored | discolored |
| | | | | | | after wiping | after wiping |
| Example B | 16.4 | 15.2 | 1.2 | 105.9 | 65.6 | Easy to | Easy to |
| | | | | | | remove and | remove and |
| | | | | | | less | less |
| | | | | | | discoloration | discoloration |

Whereas particular embodiments of this invention have been described above for purposes of illustration, it will be evident to those skilled in the art that numerous variations of the details of the present invention may be made without departing from the invention as defined in the appended claims.

What is claimed is:

1. A method of coating a polymeric substrate comprising depositing a transparent radiation curable film-forming composition over a thin metal film deposited over the polymeric substrate, wherein the transparent radiation curable film-forming composition comprises a fluorine-containing radiation curable compound.

2. The method of claim 1, wherein the thin metal film has a thickness of at least 0.2 millimicrons and no more than 5,000 millimicrons.

3. The method of claim 1, wherein the thin metal film has a thickness of at least 10 millimicrons and no more than 1,000 millimicrons.

4. The method of claim 1, wherein the thin metal film comprises a metal selected from aluminum, nickel, copper, chromium, stainless steel, stannum, and/or an alloy of any of the foregoing.

5. The method of claim 1, wherein the thin metal film is deposited by a vacuum metalizing process.

6. The method of claim 1, wherein the transparent radiation curable film-forming composition comprises a radiation-curable compound comprising polyurethane (meth)acrylate.

7. The method of claim 1, wherein the fluorine-containing radiation curable compound is represented by the general formula:
(R_{A})ₓ—W—(R_{f})_{y}
wherein:
(i) each R_{A} independently represents a radiation curable moiety;
(ii) each R_{f} independently represents a fluorinated moiety;
(iii) x is at least 2;
(iv) y is at least 1; and
(v) W is a group linking R_{A} and R_{f}.

8. The method of claim 1, wherein the fluorine-containing radiation curable compound comprises a perfluoro-type polymer.

9. The method of claim 1, wherein the fluorine-containing radiation curable compound comprises a perfluoropolyether and one or more polymerizable unsaturated groups per molecule.

10. The method of claim 9, wherein the fluorine-containing radiation curable compound is represented by the general structure: 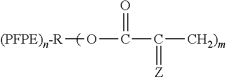
in which:
(a) PFPE is a perfluoropolyether;
(b) each n and m is independently 1 or 2;
(c) R is a linking group; and
(d) Z is H or CH₃.

11. The method of claim 10, wherein m+n=3.

12. The method of claim 11, wherein R comprises one or more urethane linkages.

13. The method of claim 1, wherein the transparent radiation curable film-forming composition further comprises inorganic particles.

14. The method of claim 13, wherein the inorganic particles comprise inorganic oxide particles.

15. The method of claim 14, wherein the inorganic oxide particles comprise silica.

16. The method of claim 13, wherein the inorganic particles are surface treated with a fluorosilane.

17. The method of claim 16, wherein the fluorosilane is represented by the following general formula:
(S_{y})ᵣ—W—(R_{f})ₛ
wherein: (a) each S_{y} independently represents a hydrolyzable silane moiety; (b) R_{f} is F or a fluorinate moiety, (c) r is at least 1; (d) s is at least 1; and (e) W is a single bond or a linking group.

18. A polymeric substrate comprising a thin metal film depositing over at least a portion of the substrate and a transparent topcoat over the thin metal film, wherein the transparent topcoat comprises a radiation cured composition comprising a fluorine-containing radiation cured compound.
